(19) United States
(12) Patent Application Publication
(10) Pub. No.: US 2026/0235938 A1
(43) Pub. Date: Aug. 13, 2026

(54) STAND FOR PHOTOGRAPHIC EQUIPMENT AND A LEG THEREFOF

(71) Applicant: ZHONGSHAN DASHAN PHOTOGRAPHIC EQUIPMENT CO., LTD., Zhongshan (CN)

(72) Inventor: Xihua Zhu, Zhongshan (CN)

(21) Appl. No.: 19/235,614

(22) Filed: Jun. 12, 2025

(30) Foreign Application Priority Data
Feb. 13, 2025 (CN) 202510162946.6

(51) Int. Cl. G03B 17/56; F16B 7/04; F16M 11/12; F16M 11/24

(52) U.S. Cl. CPC G03B 17/561; F16B 7/0433; F16M 11/126; F16M 11/242

(57) ABSTRACT

The present application provides a stand for photographic equipment and a leg. The leg includes a first tube defining a first end and a second end, and the first end defining a first slot including a longitudinal slot and a transverse groove; a first fastener configured to change a radial dimension of the first end and forming a protrusion rib to engage with the transverse groove; a second fastener having a changeable radial dimension and forming a protrusion to engage with the longitudinal slot and the protrusion rib; and a second tube movably sleeved within the channel; wherein the second fastener can lock or release the second tube. In the technical solution, the second tube may be locked or released, and it is convenient to operate; it is convenient to assembly the leg and the stand.

### CROSS-REFERENCE TO RELATED APPLICATIONS

The present disclosure claims priority of Chinese Patent Application No. 202510162946.6,filed on Feb. 13, 2025, the entire contents of which are hereby incorporated by reference.

### TECHNICAL FIELD

The present application relates to the technical field of support device, and in particular to a stand for photographic equipment and a leg thereof.

### BACKGROUND

To facilitate the operation of photographic equipment, projectors, or other instruments, height-adjustable stands are commonly used to support such devices. The adjustable stand typically includes multiple legs, each of which is made up of several tubular sections that are nested together in a telescopic manner. The height of the stand is adjusted by extending or retracting the inner tubes relative to the outer tubes. However, the legs have issues with inconvenient operation, which is time-consuming and labor-intensive.

### SUMMARY

An object of the present application is to provide a stand for photographic equipment and a leg thereof which can solve the above-described technical problems.

In order to achieve the above object, a technical solution of the present application provides a leg of a stand for photographic equipment, including:
a first tube defining a first end and a second end that are opposite to each other, a channel defined in the first tube along an axially direction of the first tube and the channel running through the first tube, the channel having an opening at the first end, a first slot extending from the opening towards the second end, and the first slot including a longitudinal slot and a transverse groove intersecting the longitudinal slot;
a first fastener disposed on an outer side of the first end and configured to change a radial dimension of the first end, and a protrusion rib formed at an inner peripheral surface of the first fastener and configured to engage with the transverse groove of the first slot to restrict the first fastener;
a second fastener disposed in an inner side of the first end, the second fastener having a changeable radial dimension, a protrusion formed on an outer peripheral surface of the second fastener, the protrusion configured to engage with the longitudinal slot of the first slot to restrict the second fastener in a circumferential direction, and the protrusion rib engaged with the protrusion to restrict the second fastener in the axial direction; and
a second tube movably sleeved within the channel of the first tube, and the second tube being able to locked at different positions within the first tube or released from the first tube by the second fastener;
wherein the radial dimension of the second fastener changes with change of the radial dimension of the first end, enabling the second fastener to lock or release the second tube.

In one of the embodiments, the protrusion is located in a district from the end of the longitudinal slot away from the first end to the transverse groove.

In one of the embodiments, one end of the protrusion in an axial direction forms an end surface, and the protruding rib resists the end surface of the protrusion.

In one of the embodiments, the protrusion is engaged in the longitudinal slot, the longitudinal slot has two opposite sides on its circumference, and the protrusion is restricted in the circumferential direction by the two sides.

In one of the embodiments, the first slot includes two transverse grooves, and two transverse grooves are respectively located on both sides of the longitudinal slot.

In one of the embodiments, a notch is defined in at least one side of the protrusion in the circumferential direction, and a part of each protruding rib is engaged in the notch, and another part of each protruding rib is engaged in the transverse groove.

In one of the embodiments, the first end of the first tube defines two first slots, thereby dividing the first end into two separate parts.

In one of the embodiments, the number of the protrusion is two, the two first slots are spaced 180° apart in the circumferential direction of the first tube, and the two protrusions are spaced 180° apart in the circumferential direction of the second fastener.

In one of the embodiments, the transverse groove is perpendicular to the longitudinal slot.

In one of the embodiments, the first end of the first tube and/or the second fastener are elastic.

In one of the embodiments, the first fastener includes an elastic ring and a trigger mechanism connected to the elastic ring, the trigger mechanism includes a tensioning shaft, a trigger, a rotating shaft, and a spring, the elastic ring is sleeved on an outer surface of the first end, the trigger resists an outer periphery surface of the elastic ring, the rotating shaft is rotatably disposed in the trigger, the tensioning shaft is connected to the elastic ring, when the trigger is driven to rotate, the elastic ring is pulled to shrink or release by the tensioning shaft so as to change a radial dimension of the first end.

In one of the embodiments, a second slot is defined in the second fastener, and the second slot extends radially through the second fastener, thereby making at least a part of the second fastener non-closed in the circumferential direction, so that the radial size of the second fastener is changeable.

In one of the embodiments, the outer peripheral surface of the second fastener is in contact with an inner peripheral surface of the first end of the first tube, and an outer surface of the second tube is in contact with an inner surface of the second fastener.

In order to achieve the above object, another technical solution of the present application provides a stand for photographic equipment, including:
a photographic pan-tilt head; and
one or more legs according to claim 1.

In one of the embodiments, the protrusion is located in a district from the end of the longitudinal slot away from the first end to the transverse groove.

In one of the embodiments, one end of the protrusion in an axial direction forms an end surface, and the protruding rib resists the end surface of the protrusion.

In one of the embodiments, the protrusion is engaged in the longitudinal slot, the longitudinal slot has two opposite sides on its circumference, and the protrusion is restricted in the circumferential direction by the two sides.

In order to achieve the above object, one more technical solution of the present application provides a leg of a stand for photographic equipment, including:
a first tube defining a first end and a second end that are opposite to each other, a channel defined in the first tube along an axially direction of the first tube and the channel running through the first tube, the channel having an opening at the first end, a first slot extending from the opening towards the second end, and the first slot including a longitudinal slot and a transverse groove intersecting the longitudinal slot;
a first fastener disposed on an outer side of the first end and configured to change a radial dimension of the first end, and a protrusion rib formed at an inner peripheral surface of the first fastener and configured to engage with the transverse groove of the first slot to restrict the first fastener;
a second fastener disposed in an inner side of the first end, the second fastener having a changeable radial dimension, a protrusion formed on an outer peripheral surface of the second fastener, the protrusion configured to engage with the longitudinal slot of the first slot to restrict the second fastener in a circumferential direction, and the protrusion rib engaged with the protrusion to restrict the second fastener in the axial direction; and
a second tube detachably connected to the second fastener;
wherein the radial dimension of the second fastener changes with change of the radial dimension of the first end, enabling the second fastener to lock or release the second tube, when the second fastener locks the second tube, the second tube is fixed relative to the first tube; when the second fastener releases the second tube, the second tube is movable axially relative to the first tube within the channel.

In the legs and the stand for photographic equipment of this application, the radial size of the first end of the first tube can be changed by applying force to the first fastener to change the radial size of the second fastener, thereby locking or releasing the second tube and making it being convenient to operate the leg and stand. Moreover, during assembly, the second fastener and the first fastener are directly sleeved on the inside and outside of the first tube respectively, and the second tube is inserted into the second fastener, thereby making it being convenient to assembly the leg and the stand.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is an isometric view of a stand for photographic equipment according to an embodiment of the present application.

FIG. 2 is a partial isometric view of a leg of the stand for photographic equipment of FIG. 1.

FIG. 3 is an exploded view of the leg of FIG. 2.

FIG. 4 is another exploded view of the leg of FIG. 2.

FIG. 5 is yet another exploded view of the leg of FIG. 2.

FIG. 6 is a front view of the leg of FIG. 2.

FIG. 7 is a cross sectional view of the leg taken along line A-A of FIG. 6.

FIG. 8 is an isometric view of a leg according to another embodiment of the stand for photographic equipment of FIG. 1.

FIG. 9 is an exploded view of a first fastener of the leg of FIG. 2.

FIG. 10 is another exploded view of a first fastener of the leg of FIG. 2.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “adial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

The terms “first,” “second,” “third,” etc., are used merely to distinguish between similar attributes or components, and do not indicate or imply any relative importance or specific order.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

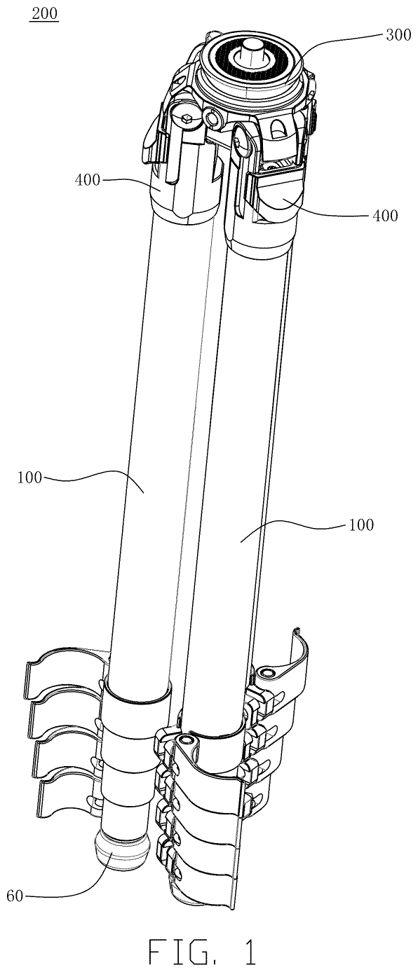

Referring to FIG. 1, a stand 200 for photographic equipment of the present application is configured to be supported on flat or uneven surfaces, such as tabletops or ground, and configured to support an equipment including photographic equipment (such as camara, camcorders, and photography light etc.), projectors, or other precision instruments. In the embodiment, the stand 200 is configured to be applied in photographic equipment. The stand 200 for photographic equipment includes extendable legs 100. In this embodiment, the stand 200 for photographic equipment includes a plurality of legs 100, for example three legs 100 (i.e., the stand 200 for photographic equipment is a tripod). In another embodiments, the stand 200 for photographic equipment may include a single leg 100 (i.e. the stand 200 for photographic equipment is a monopod) or two or more legs 100. The plurality of legs 100 may be splayed at a certain angle, and an overall height of the stand 200 for photographic equipment may be adjusted by controlling a splaying degree of the legs 100, allowing the camera to be fixed at a desired shooting height. It should be noted that since the stand 200 for photographic equipment is extendable and retractable, it can also be applied to other equipment requiring variable height. As shown in FIG. 1, the three legs 100 are folded to make the stand 200 typically in a storage state for easy portability and storage. When the three legs 100 are rotated in a certain angle to splay, the stand 200 is usually in a usable state, ready to support the equipment on a tabletop or the ground.

Specifically, when the stand 200 for photographic equipment is used as a photographic stand, the stand 200 for photographic equipment may further include a photographic pan-tilt head.

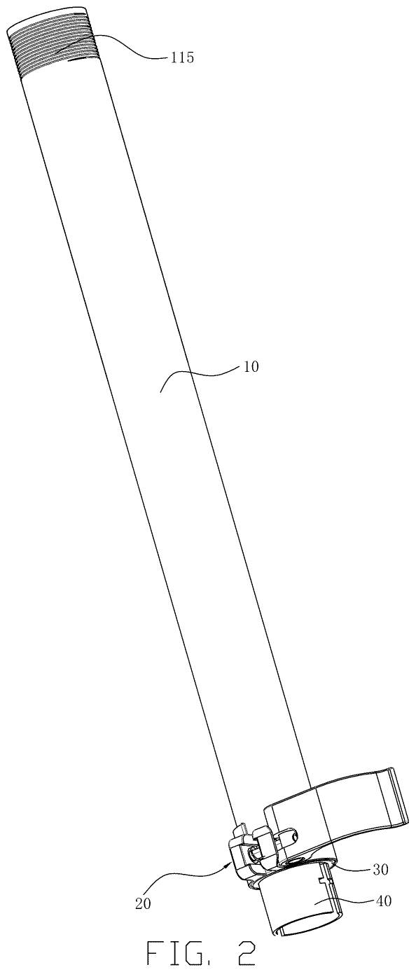

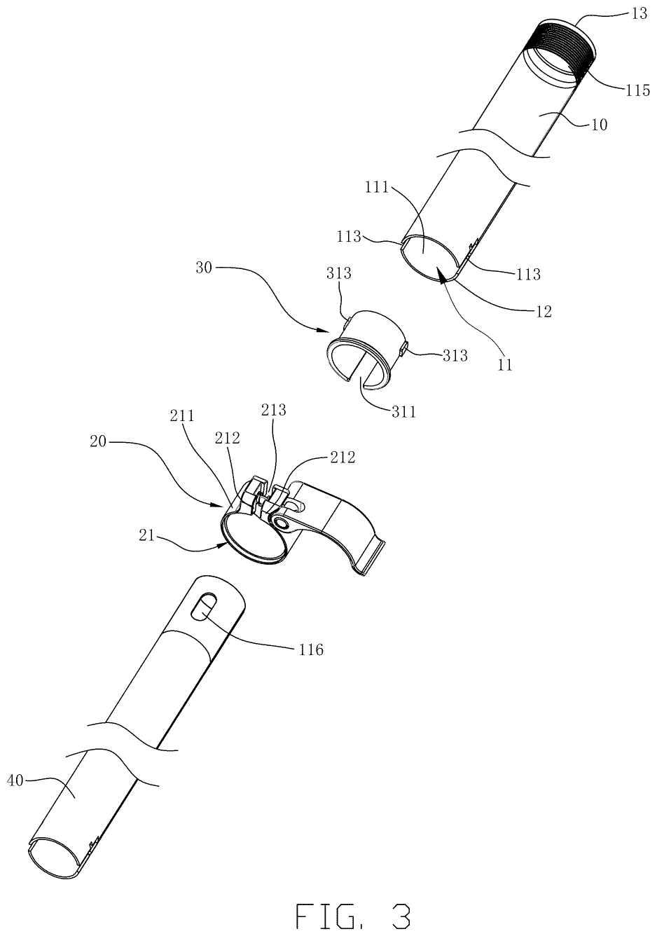

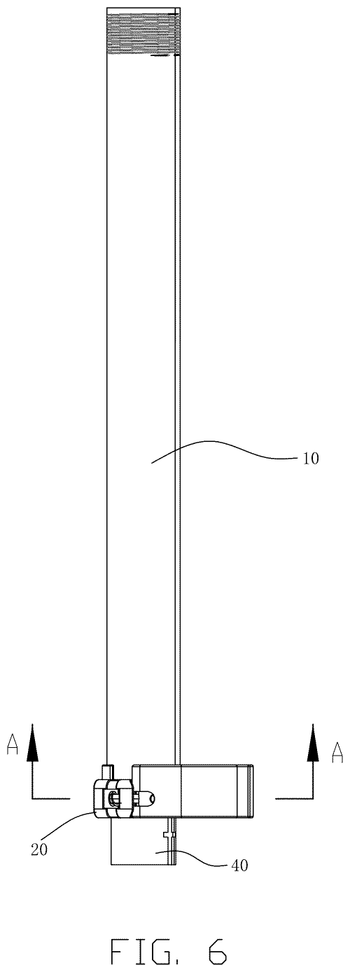

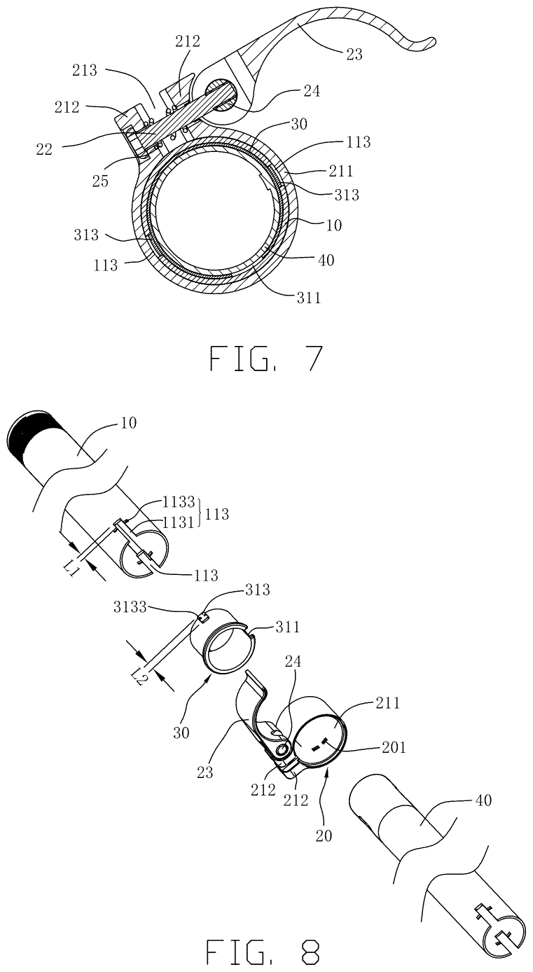

Please referring to FIGS. 2 to 7, the leg 100 according to one embodiment of the present application includes a first tube 10, a first fastener 20 sleeved on an outer side of the first tube 10, a second fastener 30 sleeved in an inner side of the first tube 10, and a second tube 40 for connecting with the second fastener 30. A channel 11 is defined in the first tube 10 along an axial direction of the first tube 10 and the channel 11 runs through the first tube 10. The second tube 40 is movably sleeved inside the first tube 10 along the axial direction of the first tube 10. The first tube 10 has a first end 12 and a second end 13 that are opposite to each other in an axial direction of the first tube 10. A radial size of the first end 12 is changeable. The second end 13 is configured to connect to an equipment to be supported or to other tubes, and the first end 12 is configured to connect to the second tube 40.

In this embodiment, the first fastener 20 is disposed on the outer side of the first end 12 of the first tube 10 and is configured to apply a radial force to the first end 12. When force is applied to the first end 12, the radial size of the first end 12 changes. The second fastener 30 is disposed inside the inner side of the first end 12 and is detachably connected to the second tube 40, so as to releasably lock the second tube 40. When the radial size of the first end 12 of the first tube 10 changes, the first end 12 acts on the second fastener 30, causing the second fastener 30 to lock or release the second tube 40. When the second tube 40 is released, the second tube 40 is movable axially within the channel 11 to extend or retract relative to the first tube 10. In the state shown in FIG. 2, the second tube 40 is fully retracted into the first tube 10; when the second tube 40 is locked by the second fastener 30, the second tube 40 is fixed relative to the first tube 10. By setting the first fastener 20 on the outer side and the second fastener 30 on the inner side of the first tube 10, a diameter of the first tube 10 is easily adjustable to lock and release the second tube 40, making it convenient to be operated. It should be noted that the leg 100 includes a plurality of nested tubes to form multiple sets of modules including one first tube 10 and one second tube 40. A second tube 40 is nested within a preceding outer first tube 10 and serves as an outer first tube 10 for the next inner second tube 40. That is, except for the outermost tube and innermost tube, each tube serves both as a first tube 10 to cooperate with an outer tube and as a second tube 40 to cooperate with an inner tube.

In this embodiment, the first tube 10 is cylindrical, with a lower end being the first end 12 and an upper end being the second end 13. The second end 13 is configured to support an equipment or to connect to other tubes. The channel 11 has an opening 111 at the first end 12, and a first slot 13 is defined in the first end 12. The first slot 13 extends from the opening 111 towards the second end 13. The first slot 113 includes a longitudinal slot 1131 extending axially and a transverse groove 1133 intersecting the longitudinal slot 1131. Specifically, in this embodiment, the transverse groove 1133 is perpendicular to the longitudinal slot 1131. It should be understood that the transverse groove 1133 may not be perpendicular to the longitudinal slot 1131, but may intersect the longitudinal slot 1131 at an oblique angle. More specifically, two transverse grooves 1133 are respectively located on both sides of the longitudinal slot 1131. Specifically, the first end 12 of the first tube 10 defines two first slots 113, thereby dividing the first end 12 into two separate parts. More specifically, the two first slots 113 are spaced 180° apart in the circumferential direction of the first tube 10. The terms “axial” and “radial” in this context refer to the axial and radial directions of the leg 100. In this embodiment, the transverse groove 1133 intersects the middle portion of the longitudinal slot 1131. Certainly, the transverse groove 1133 may also intersect other positions of the longitudinal slot 1131 other than the middle portion.

Specifically, if the first tube 10 is the outermost tube, the second end 13 of the first tube 10 may have external threads 115 to connect to a supporting portion 400 of the leg 100 (see FIG. 1), and the leg 100 is hinged to a base 300 of the stand 200 for photographic equipment (see FIG. 1) via the supporting part 400. It should be understood that the external threads 115 may also be replaced by other connection structures, and there is no limitation here. If the first tube 10 is an inner tube other than the outermost tube, the second end 13 of the first tube 10 may define a connection hole 116. Specifically, the connection hole 116 may be an elongated hole.

When a radial inward force is applied on the first end 12, due to the presence of the first slot 113, the two separated parts of the first end 12 may move closer to each other, reducing the circumferential width of the first slot 113 and thus shrinking the radial size of the first end 12. As a result, the radial size of the channel 11 changes at the part corresponding to the first end 12. The first end 12 is elastic and can undergo elastic deformation. For example, the first tube 10 may be made of an elastic material. When the external force applied on the first end 12 is removed, the deformation of the first slot 113 can be recovered, and the radial size of the first tube 10 may return to its original size in the free state. Certainly, when the first end 12 is made of a deformable material, the radial size of the first end 12 may also shrink under a radial inward force even without the first slot 113. Therefore, the reduction in the radial size of the first end 12 does not necessarily depend on the presence of the first slot 113.

In this embodiment, the second fastener 30 is fixedly connected to the first tube 10. Specifically, the second fastener 30 is sleeved in the inner side of the first end 12 of the first tube 10, and the outer peripheral surface of the second fastener 30 is in contact with the inner peripheral surface of the first end 12 of the first tube 10. A second slot 311 is defined in the second fastener 30, and the second slot 311 extends radially through the second fastener 30, thereby making at least a part of the second fastener 30 non-closed in the circumferential direction. Preferably, the second slot 311 extends along an entire length of the second fastener 30, that is, the second fastener 30 is in the form of a non-closed ring, so that the radial size of any portion at the entire length of the second fastener 30 may be changed. It should be understood that two second slots 311 extending along the entire length of the second fastener 30 may be defined in the second fastener 30, that is, the second fastener 30 may consist of two separate semi-cylindrical segments, which makes the radial size of the second fastener 30 being changeable. Certainly, the second fastener 30 may also consist of three or more separate segments, and there is no limitation here.

When a radial inward force is applied on the second fastener 30, due to the presence of the second slot 311, the two ends of the second fastener 30 along the circumference may move closer to each other, reducing the circumferential width of the second slot 311 and thus shrinking the radial size of the second fastener 30. The second fastener 30 is elastic and may undergo elastic deformation. For example, the second fastener 30 may be made of an elastic material. When the external force applied on the second fastener 30 is removed, the deformation of the second slot 311 can be recovered, and the radial size of the second fastener 30 may return to its original size in the free state. Since the second fastener 30 is sleeved inside the first tube 10, when a radial inward force is applied on the first end 12 of the first tube 10 to make a radial size of the first tube 10 to shrink, the radial inward force is transmitted from the first tube 10 to the second fastener 30, causing the radial size of the second fastener 30 to shrink.

Specifically, a protrusion 313 is formed on an outer peripheral surface of the second fastener 30, and the protrusion 313 is configured to engage with the longitudinal slot 1131 of the first slot 113 of the first tube 10 to restrict the second fastener 30 in the circumferential direction, that is, to limit a circumferential rotation of the second fastener 30 relative to the first tube 10. More specifically, the protrusion 313 is configured to be engaged into the longitudinal slot 1131 of the first slot 113. The longitudinal slot 1131 has two opposite sides 1135 on its circumference, and the protrusion 313 is restricted in the circumferential direction by the two sides 1135. Specifically, a distance L1 from an end of the longitudinal slot 1131 away from the first end 12 to the transverse groove 1133 is essentially equal to an axial length L2 of the protrusion 313, and L1 is preferably slightly larger than L2 to facilitate assembly. In this embodiment, the protrusion 313 is located in a district from the end of the longitudinal slot 1131 away from the first end 12 to the transverse groove 1133, and one end of the protrusion 313 in an axial direction forms an end surface 3131. Specifically, a width of the protrusion 313 in the circumferential direction is essentially equal to a width of the longitudinal slot 1131 of the first slot 113 in the circumferential direction, and the width of the protrusion 313 in the circumferential direction is preferably slightly smaller than the width of the longitudinal slot 1131 in the circumferential direction. Specifically, corresponding to the number of the first slots 113, the number of the protrusions 313 may be two, with the two protrusions 313 being spaced 180° apart in the circumferential direction of the second fastener 30. It should be understood that the first slot 113 and the protrusion 313 may be one, three, or more than three in number. Specifically, the protrusion 313 is located at one end of the second fastener 30 (i.e., an upper end of the outer peripheral surface). It should be understood that the term “essentially equal to” in this context means roughly equivalent but not absolutely equal.

After assembly, the second fastener 30 is sleeved inside the first end 12 of the first tube 10, and the protrusion 313 of the second fastener 30 is engaged within the longitudinal slot 1131 of the first slot 113 of the first tube 10. When a radial inward force is applied on the first end 12 of the first tube 10, the two separated parts of the first end 12 move closer to each other, thus reducing the radial size of the first end 12. Thereby, a radial inward force is applied to the second fastener 30, making two ends of the second fastener 30 in the circumferential direction to move closer to each other, thereby shrinking the radial size of the second fastener 30 to lock the second tube 40 connected to the second fastener 30. Similar to the first end 12 of the first tube 10, the second fastener 30 is elastic either, and the change of the radial size of the second fastener 30 is reversible. When the force applied to the first end 12 of the first tube 10 is removed, the radial size of the first end 12 returns to its original size, which allows the second fastener 30 to return to its original size. This releases the second tube 40 connected to the second fastener 30, allowing the second tube 40 to move relative to the first tube 10 to adjust the leg 100 to a desired length.

Specifically, the second tube 40 passes through the second fastener 30, i.e., the second fastener 30 is sleeved on the outer periphery of the second tube 40, and the second tube 40 is movably fitted within the channel 11 of the first tube 10. The outer surface of the second tube 40 is in contact with the inner surface of the second fastener 30. It should be understood that the inner diameters of the first tube 10, the second fastener 30, and the second tube 40 decrease successively, allowing the second tube 40 to pass through the second fastener 30 and move axially within the channel 11 of the first tube 10. As previously mentioned, when the first end 12 of the first tube 10 experiences a reduction in radial size due to a radial force, the radial size of the second fastener 30 also decreases. This causes the second fastener 30 to lock the second tube 40 inside the second fastener 30, thereby preventing the second tube 40 from moving axially within the channel 11 of the first tube 10. Since the deformation of the first slot 113 and the second slot 311 is reversible, when the force applied to the first tube 10 is removed, the deformation of the first slot 113 and the second slot 311 recovers. As a result, a locking force applied to the second tube 40 from the second fastener 30 is released, allowing the second tube 40 to move to adjust the leg 100 to a desired length. In this way, the second tube 40 can be locked at different positions within the first tube 10 by the second fastener 30 or released from the first tube 10. When the second fastener 30 locks the second tube 40, the second tube 40 is fixed relative to the first tube 10. When the second fastener 30 releases the second tube 40, the second tube 40 is movable axially within the channel 11 relative to the first tube 10.

In this embodiment, the first fastener 20 is configured to change the radial size of the first end 12.

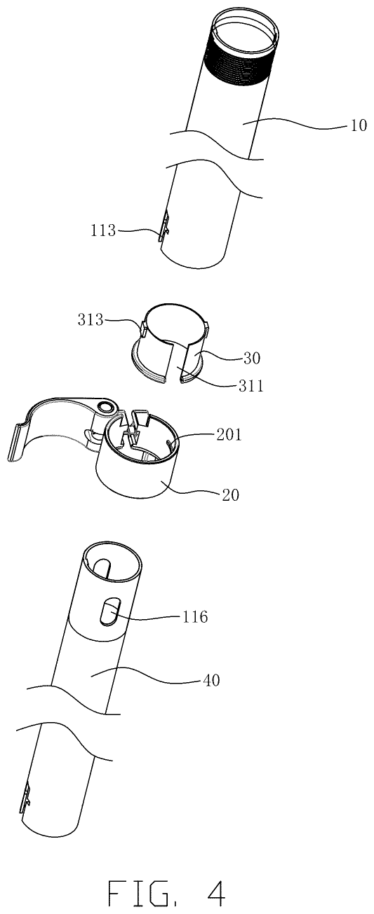

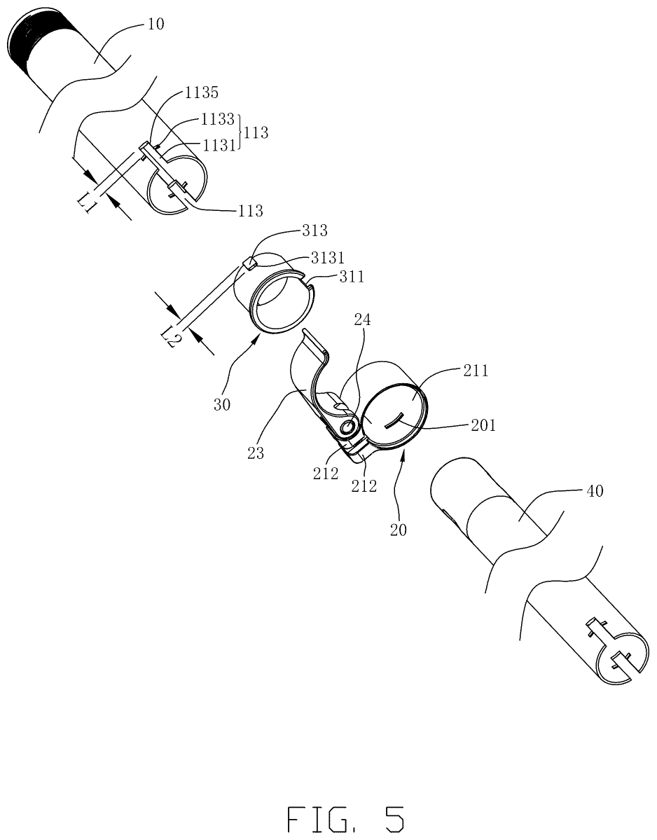

In this embodiment, referring to FIG. 4 and FIG. 5, a protruding rib 201 is formed at an inner peripheral surface of the first fastener 20 and extends in the circumferential direction of the first fastener 20. The protruding rib 201 is configured to engage with the protrusion 313 of the second fastener 30 to restrict the second fastener 30 in the axial direction. The protruding rib 201 is also configured to engage with the transverse groove 1133 of the first slot 113 of the first tube 10 to restrict the first fastener 20. In this embodiment, the protruding rib 201 is configured to be received in the transverse groove 1133 of the first slot 113 of the first tube 10. In this embodiment, the protruding rib 201 resists the end surface 3131 of the protrusion 313. Specifically, in this embodiment, the protruding rib 201 confines the protrusion 313 within the district on one side of the transverse groove 1133 of the longitudinal slot 1131.

Please referring to FIG. 8, in another embodiment, a notch 3133 is defined in at least one side of the protrusion 313 in the circumferential direction, and two protruding ribs 201 are provided. A part of each protruding rib 201 is engaged in the notch 3133, and another part of each protruding rib 201 is engaged in the transverse groove 1133. In this case, the distance L1 from the end of the longitudinal slot 1131 away from the first end 12 to the transverse groove 1133 may be smaller than the axial length L2 of the protrusion 313, meaning that the protrusion 313 is not entirely located within the district from the end of the longitudinal slot 1131 away from the first end 12 to the transverse groove 1133. It should be understood that the protruding rib 201 may be only one. When only one protruding rib 201 is provided, there is only one transverse groove 1133 and one notch 3133.

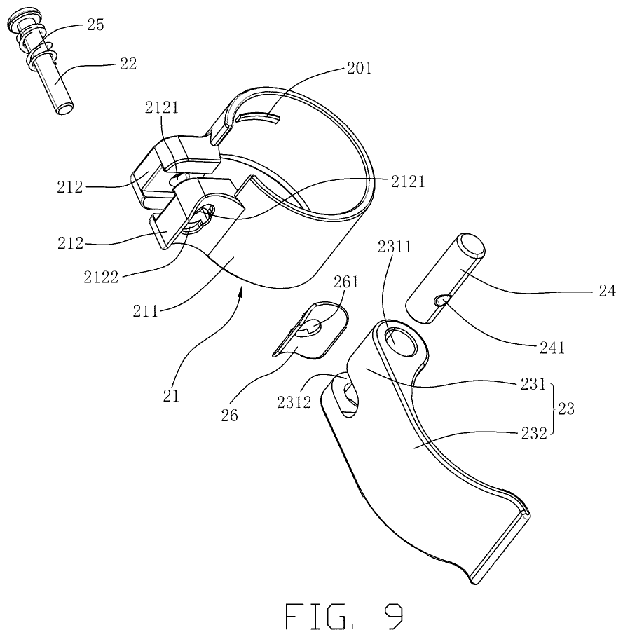

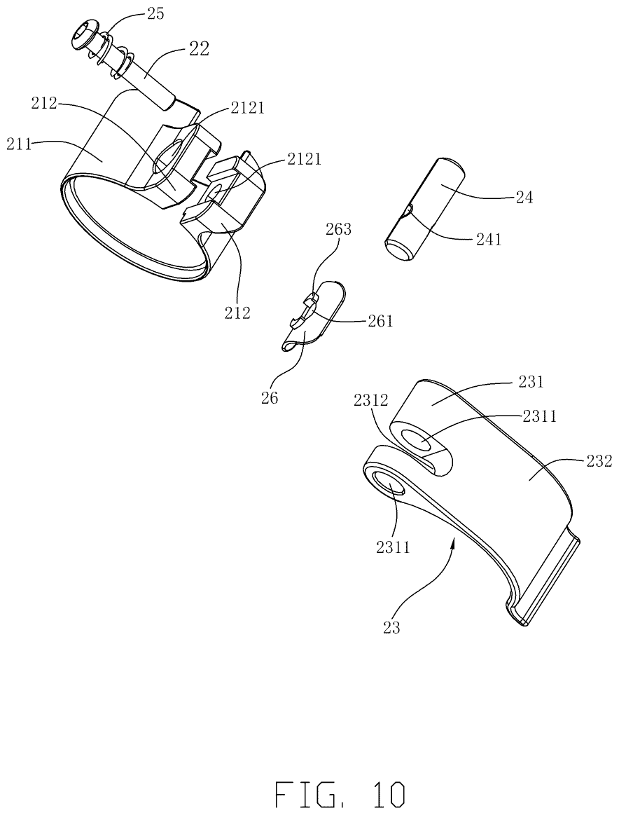

Please referring to FIG. 9 and FIG. 10, in this embodiment, the first fastener 20 includes an elastic ring 21. The elastic ring 21 includes an encircling section 211 and two free ends 212 in the circumferential direction. The encircling section 211 is connected between the two free ends 212. The two free ends 212 are spaced apart from each other, thus forming a third slot 213. When the distance between the two free ends 212 is changed, i.e., when a width of the third slot 213 in the circumferential direction changes, a radial size of the encircling section 211 changes. The encircling section 211 is arc-shaped and is sleeved around the outer periphery of the first end 12. The inner surface of the encircling section 211 resists an outer surface of the first end 12. Specifically, the aforementioned protruding rib 201 is located on the inner surface of the encircling section 211 of the elastic ring 21 of the first fastener 20.

Specifically, the first fastener 20 further includes a trigger mechanism connected to the elastic ring 21, which is configured to adjust the tightness of the elastic ring 21. The trigger mechanism includes a tensioning shaft 22, a trigger 23, a rotating shaft 24, and a spring 25. The tightness of the elastic ring 21 may be changed by the rotating shaft 24 and the trigger 23 being movably matched to hold the tensioning shaft 22. The elastic ring 21 is sleeved on an outer surface of the first end 12, the trigger 23 resists an outer periphery surface of the elastic ring 21, the rotating shaft 24 is rotatably disposed in the trigger 23, the tensioning shaft 22 is connected to the elastic ring 21, when the trigger 23 is driven to rotate, the elastic ring 21 is pulled to shrink or release by the tensioning shaft 22 so as to change the radial dimension of the first end 12.

Specifically, the trigger 23 includes a handle 232 for the user to operate and a biasing portion 231 located at one end of the handle 232. In the direction perpendicular to a transverse direction of the handle 232, a thickness of the biasing portion 231 is greater than a thickness of the handle 232. In this embodiment, a cross-section of the biasing portion 231 is drop-shaped. The biasing portion 231 resists a connecting portion of the elastic ring 21, and the connecting portion is at a connection position of one free end 212 and the encircling section 211. The handle 232 extends along a circumferential direction of the encircling section 211. The biasing portion 231 defines a first through-hole 2311 that extends axially and a second through-hole 2312 that extends radially. The first through-hole 2311 and the second through-hole 2312 are communicated with each other. A cylindrical rotating shaft 24 is disposed in the first through-hole 2311. The rotating shaft 24 defines a third through-hole 241 that extends radially. The second through-hole 2312 and the third through-hole 241 are coaxial. Each of the two free ends 212 of the elastic ring 21 defines a fourth through-hole 2121 for the tensioning shaft 22 to pass through. The tensioning shaft 22 sequentially passes through the fourth through-holes 2121 of the two free ends 212, then passes through the second through-hole 2312 of the biasing portion 231, and connects to the rotating shaft 24 via the third through-hole 241. A spring 25 is sleeved around the tensioning shaft 22, with both two ends of the spring 25 resisting the two free ends 212 of the first fastener 20 respectively. When the trigger 23 is tightened, the rotating shaft 24 pulls the tensioning shaft 22, causing the two free ends 212 to move closer to each other, thereby contracting the first end 12 and locking the second tube 40 to the first tube 10 as previously described. When the trigger 23 is moved in the opposite direction, the spring 25 returns to its original state to push the two free ends 212 apart from each other by two ends of the spring 25, and the second fastener 20 returns to its original shape, thereby releasing the second tube 40 from the first tube 10. At this time, the second tube 40 is movable axially within the first tube 10. Once a desired length of the leg 100 is achieved, the trigger 23 can be tightened again to lock the second tube 40.

It should be understood that in other embodiments, the trigger mechanism may also be replaced by a bolt. That is, a head of the bolt resists the outer side of one of the free ends, the bolt shaft passes through the holes of the two free ends and is connected to a nut. The two free ends may move closer to each other by tightening the bolt and nut relative to each other. Conversely, the two free ends may move apart by loosening the bolt and nut, thereby changing the diameter of the elastic ring and the radial size of the first end of the first tube. Similarly, a spring may also be sleeved on the bolt, with the spring located in front of the two free ends, in order to provide a biasing force between the two free ends.

Preferably, a wear-resistant plate 26 is provided between the trigger 23 and an adjacent free end 212. The wear-resistant plate 26 defines a fifth through-hole 261 that extends radially, which allows the tensioning shaft 22 to pass through. Further preferably, the free end 212 adjacent to the wear-resistant plate 26 defines a sixth through-hole 2122 that extends radially. The wear-resistant plate 26 forms a second protrusion 263. When the wear-resistant plate 26 is located between the trigger 23 and the corresponding free end 212, the second protrusion 263 of the wear-resistant plate 26 engages with the sixth through-hole 2122 of the free end 212. This prevents the wear-resistant plate 26 from moving when the trigger 23 rotates. Preferably, there are two sixth through-holes 2122, located at two axial ends of the fourth through-hole 2121. Correspondingly, there are two second protrusions 263.

When assembling the leg 100 in this embodiment, firstly, the second fastener 30 may be inserted into the inner side of the first end 12 of the first tube 10 through the opening 111 with the protrusion 313 of the second fastener 30 engaged with the longitudinal slot 1131 of the first slot 113 of the first end 12 of the first tube 10, so as to restrict the second fastener 30 in the circumferential direction. Next, the first fastener 20 is sleeved on the outer side of the first end 12, with the protruding rib 201 received in the transverse groove 1133 of the first slot 113 of the first end 12 of the first tube 10, so as to restrict the second fastener 30 in the axial direction. Subsequently, the second tube 40 is inserted into the second fastener 30, and the trigger 23 is tightened, so as to lock the second tube 40.

In this embodiment, the leg 100 may further include a third tube and more tubes. Multiple sections of tubes are nested in sequence and are movable relative to each other. Two connected tubes are connected by a set of the aforementioned first fastener and second fastener. Each set of first fastener and second fastener can lock and restrict the relative movement between the two connected tubes, or release the restriction on the relative movement of the two connected tubes. In this embodiment, the number of the tubes in the leg 100 is five, and in other embodiments, the number of the tubes may be less than five or more than five.

In this embodiment, the leg 100 further includes a support pad 60, and the support pad 60 is connected to the innermost tube and located at the end of the leg 100 away from the supporting portion 400. The leg 100 is supported on a tabletop or ground via the support pad 60.

In the legs and the stand for photographic equipment of this application, the radial size of the first end of the first tube can be changed by applying force to the first fastener to change the radial size of the second fastener, thereby locking or releasing the second tube and making it being convenient to operate the leg and stand. Moreover, during assembly, the second fastener and the first fastener are directly sleeved on the inside and outside of the first tube respectively, and the second tube is inserted into the second fastener, thereby making it being convenient to assembly the leg and the stand.

Finally, it should be noted that: the above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

What is claimed is:

1. A leg of a stand for photographic equipment, comprising:
a first tube defining a first end and a second end that are opposite to each other, a channel defined in the first tube along an axially direction of the first tube and the channel running through the first tube, the channel having an opening at the first end, a first slot extending from the opening towards the second end, and the first slot comprising a longitudinal slot and a transverse groove intersecting the longitudinal slot;
a first fastener disposed on an outer side of the first end and configured to change a radial dimension of the first end, and a protrusion rib formed at an inner peripheral surface of the first fastener and configured to engage with the transverse groove of the first slot to restrict the first fastener;
a second fastener disposed in an inner side of the first end, the second fastener having a changeable radial dimension, a protrusion formed on an outer peripheral surface of the second fastener, the protrusion configured to engage with the longitudinal slot of the first slot to restrict the second fastener in a circumferential direction, and the protrusion rib engaged with the protrusion to restrict the second fastener in the axial direction; and
a second tube movably sleeved within the channel of the first tube, and the second tube being able to locked at different positions within the first tube or released from the first tube by the second fastener;
wherein the radial dimension of the second fastener changes with change of the radial dimension of the first end, enabling the second fastener to lock or release the second tube.

2. The leg according to claim 1, wherein the protrusion is located in a district from the end of the longitudinal slot away from the first end to the transverse groove.

3. The leg according to claim 2, wherein and one end of the protrusion in an axial direction forms an end surface, and the protruding rib resists the end surface of the protrusion.

4. The leg according to claim 1, wherein the protrusion is engaged in the longitudinal slot, the longitudinal slot has two opposite sides on its circumference, and the protrusion is restricted in the circumferential direction by these two sides.

5. The leg according to claim 1, wherein the first slot comprises two transverse grooves, and two transverse grooves are respectively located on both sides of the longitudinal slot.

6. The leg according to claim 1, wherein a notch is defined in at least one side of the protrusion in the circumferential direction, and a part of each protruding rib is engaged in the notch, and another part of each protruding rib is engaged in the transverse groove.

7. The leg according to claim 1, wherein the first end of the first tube defines two first slots, thereby dividing the first end into two separate parts.

8. The leg according to claim 7, wherein the number of the protrusion is two, the two first slots are spaced 180° apart in the circumferential direction of the first tube, and the two protrusions are spaced 180° apart in the circumferential direction of the second fastener.

9. The leg according to claim 1, wherein the transverse groove is perpendicular to the longitudinal slot.

10. The leg according to claim 1, wherein the first end of the first tube and/or the second fastener are elastic.

11. The leg according to claim 1, wherein the first fastener 20 comprises an elastic ring and a trigger mechanism connected to the elastic ring, the trigger mechanism comprises a tensioning shaft, a trigger, a rotating shaft, and a spring, the elastic ring is sleeved on an outer surface of the first end, the trigger resists an outer periphery surface of the elastic ring, the rotating shaft is rotatably disposed in the trigger, the tensioning shaft is connected to the elastic ring, when the trigger is driven to rotate, the elastic ring is pulled to shrink or release by the tensioning shaft so as to change a radial dimension of the first end.

12. The leg according to claim 1, wherein a second slot is defined in the second fastener, and the second slot extends radially through the second fastener, thereby making at least a part of the second fastener non-closed in the circumferential direction, so that the radial size of the second fastener is changeable.

13. The leg according to claim 1, wherein the outer peripheral surface of the second fastener is in contact with an inner peripheral surface of the first end of the first tube, and an outer surface of the second tube is in contact with an inner surface of the second fastener.

14. A stand for photographic equipment, comprising:
a photographic pan-tilt head; and
one or more legs according to claim 1.

15. The stand for photographic equipment according to claim 14, wherein the protrusion is located in a district from the end of the longitudinal slot away from the first end to the transverse groove.

16. The stand for photographic equipment according to claim 15, wherein and one end of the protrusion in an axial direction forms an end surface, and the protruding rib resists the end surface of the protrusion.

17. The stand for photographic equipment according to claim 14, wherein the protrusion is engaged in the longitudinal slot, the longitudinal slot has two opposite sides on its circumference, and the protrusion is restricted in the circumferential direction by the two sides.

18. A leg of a stand for photographic equipment, comprising:
a first tube defining a first end and a second end that are opposite to each other, a channel defined in the first tube along an axially direction of the first tube and the channel running through the first tube, the channel having an opening at the first end, a first slot extending from the opening towards the second end, and the first slot comprising a longitudinal slot and a transverse groove intersecting the longitudinal slot;
a first fastener disposed on an outer side of the first end and configured to change a radial dimension of the first end, and a protrusion rib formed at an inner peripheral surface of the first fastener and configured to engage with the transverse groove of the first slot to restrict the first fastener;
a second fastener disposed in an inner side of the first end, the second fastener having a changeable radial dimension, a protrusion formed on an outer peripheral surface of the second fastener, the protrusion configured to engage with the longitudinal slot of the first slot to restrict the second fastener in a circumferential direction, and the protrusion rib engaged with the protrusion to restrict the second fastener in the axial direction; and
a second tube detachably connected to the second fastener;
wherein the radial dimension of the second fastener changes with change of the radial dimension of the first end, enabling the second fastener to lock or release the second tube, when the second fastener locks the second tube, the second tube is fixed relative to the first tube; when the second fastener releases the second tube, the second tube is movable axially relative to the first tube within the channel.
